(19) United States
(12) Patent Application Publication
(10) Pub. No.: US 2006/0283820 A1
(43) Pub. Date: Dec. 21, 2006

(54) Pull-out gun racking system

(76) Inventors: Crawford Peters, MacConnelesburg, PA (US); Bradley Bard, Chambersburg, PA (US); Thomas R. Stine, Greencastle, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 11/141,937

(22) Filed: Jun. 1, 2005

(51) Int. Cl. B60R 7/14

(52) U.S. Cl. 211/64

(57) ABSTRACT

A enclosure including a racking system for storing firearms and other valuables is disclosed. The racking system can include a first rail where the first rail can be secured to a bottom interior surface of an enclosure. The racking system can also include a rack secured to the first rail so that the rack is slidably attached to the enclosure. The rack can include a bottom for supporting firearms, a top having a plurality of openings, and a set of arms connecting the bottom and the top. The racking system can also include a second rail where second rail is secured to a top interior surface of the enclosure. A drawer can be secured to the second rail so that the drawer is slidably attached to the enclosure and can independently move in relation to the rack.

### FIELD OF THE INVENTION

The present invention relates generally to an enclosure including a racking system for the storage of valuables, and more particularly, for the storage of firearms and other valuables.

### BACKGROUND OF THE INVENTION

Today, millions of Americans own firearms or other types of weapons for recreational use. For those Americans, owning just one firearm is not the norm. Such a person likely owns multiple firearms and has a need for safely storing the firearms when they are not in use.

Several patents have been issued relating to gun safes and firearm enclosures for safely securing firearms when they are not in use. Among those are firearm enclosures that simply allow for stacking of the firearms around the interior of the enclosure. These simple enclosures suffer from several drawbacks. First, the simple enclosure promotes the stacking of firearms. Once the firearms are stacked on each other, the owner or user must move or remove all firearms around the targeted firearm in order to access it for use. Further, when firearms are stacked on each other, damage to the firearms may result from the weight and pressure of other firearms pressing against it during storage and removal.

Some have attempted to address these drawbacks and limitations. For example, U.S. Patent Application No. 2004/0140280, sought by Cleveland et al., discloses a cabinet that may be selectively moved into and out of the interior compartment of an enclosure for the storage of guns. The Cleveland et al. patent application publication also has drawbacks. First, the storage device is limited to only two sliding cabinets because the set of upper and lower rails are secured only to interior wall surfaces. Second, because the gun rack is coupled to a first surface, the cabinet must be pivoted relative to the safe to allow for access from both sides of the enclosure. Further, the firearms in the Cleveland et al. patent application must all be oriented the same in direction to secure them in the gun rack. Finally, while the Cleveland et al. patent does disclose shelves coupled to the cabinets, the shelves are not incorporated independent from the cabinet. Therefore, in order to access the shelves in the Cleveland et al. application, the cabinet must be withdrawn from the enclosure.

Accordingly, there exists a need for a gun racking system that resolves the aforementioned drawbacks and deficiencies.

### SUMMARY OF THE INVENTION

The following summary provides an overview of various aspects of the invention. It is not intended to provide an exhaustive description of all of the important aspects of the invention, or to define the scope of the invention. Rather, this summary is intended to serve as an introduction to the detailed description and figures that follow.

Firearms and other valuables can be stored by owners in a precise and user-friendly slide-out gun racking system. Firearms or other valuables may be shelved on a pull-out assembly that can be mounted on drawer slides allowing the end user to easily access his or her firearms or valuables by simply sliding out each individual rack installed in the enclosure.

The user-friendly sliding gun racking system eliminates the need to empty the safe, (front to rear) for a gun or other valuable by an individual who may want the particular gun or other valuable stacked or positioned in the rear of the enclosure. Further, use of the sliding gun racking system protects the firearms or other valuables from falling or rubbing on other items in the enclosure and can eliminate any damage that may occur during the insertion or withdrawing of the firearms from the safe.

An enclosure may have one or more sliding gun racks and overhead utility drawers for storing of firearms or other valuables. The sliding gun racks may be incorporated in new enclosures, for example, or be adapted to fit in existing enclosures.

Additional features and advantages of the invention will be made apparent from the following detailed description of illustrative embodiments.

### BRIEF DESCRIPTION OF THE DRAWINGS

The foregoing summary, as well as the following detailed description, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is an isometric view of an exemplary enclosure with a set of pull-out gun racking systems in accordance with the present invention;

FIG. 2 is an isometric view of an exemplary enclosure with a pull-out gun racking systems extended in accordance with the present invention;

FIG. 3 is an isometric view of an exemplary pull-out gun rack system in accordance with the present invention;

FIG. 4 is a detailed view of a portion of the top of a pull-out gun racking system in accordance with the present invention;

FIG. 5 is an isometric view of an exemplary enclosure with a set of three pull-out gun racking systems in accordance with the present invention;

FIG. 6 is an isometric view of an exemplary enclosure with a pull-out gun racking systems and an overhead pull-out gun racking system in accordance with the present invention; and

FIG. 7 is an is an isometric view of an exemplary enclosure with only a set of three pull-out gun racking systems and no shelving units in accordance with the present invention.

### DETAILED DESCRIPTION OF ILLUSTRATIVE EMBODIMENTS

In the following, a detailed description of the present invention is given with reference to the drawings.

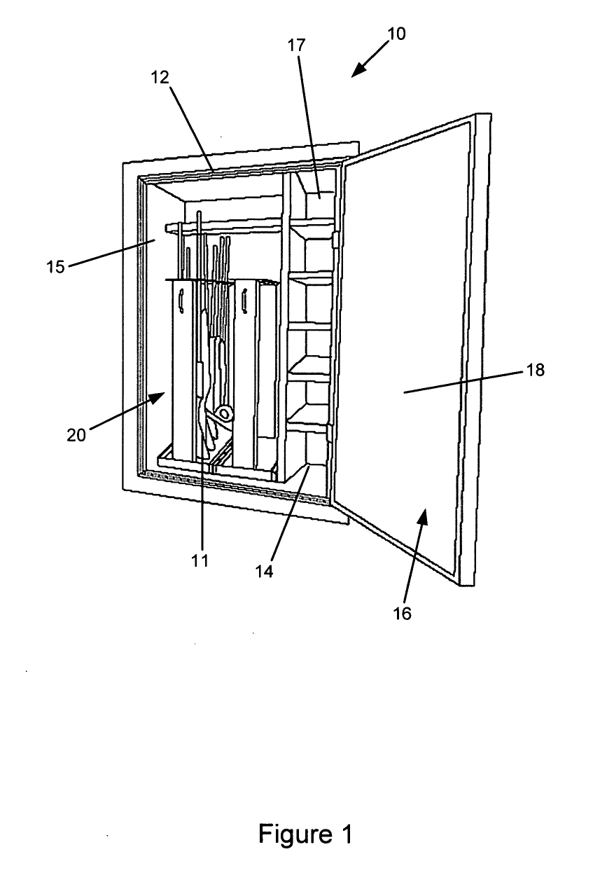

FIG. 1 depicts exemplary enclosure 10 with a set of pull-out gun racks 20 in accordance with the present invention. The enclosure includes an interior top surface 12, an interior bottom surface 14, and two interior sides 15. The enclosure 10 also includes a door 16 having an interior surface 18 for securing the firearms 11 or other valuables when they are not in use. The enclosure 10 can be a firearm safe, for example. A firearm can include rifles, shotguns, and handguns, for example. The term firearm, however, is not limited to solely weapons capable of firing a projectile using an explosive charge as a propellant.

The enclosure 10 depicted in FIG. 1 can further include shelving units 17 allowing for further storage of valuables. The interior top surface 12, interior bottom surface 14, two interior sides 15, shelving 17, and interior surface of the door 18 can be lined with a soft material or carpeted to prevent damage to firearms or valuables placed inside the enclosure 10. The pull-out gun racks 20 in FIG. 1 are positioned inside the enclosure 10 for storage of the firearms 11.

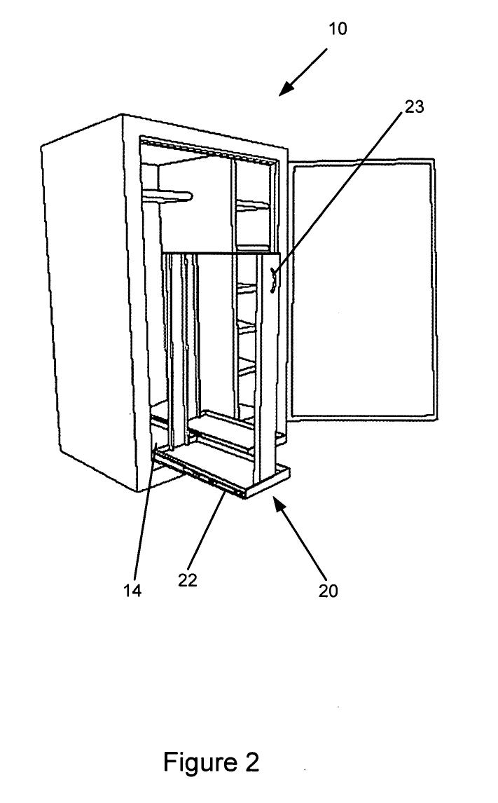

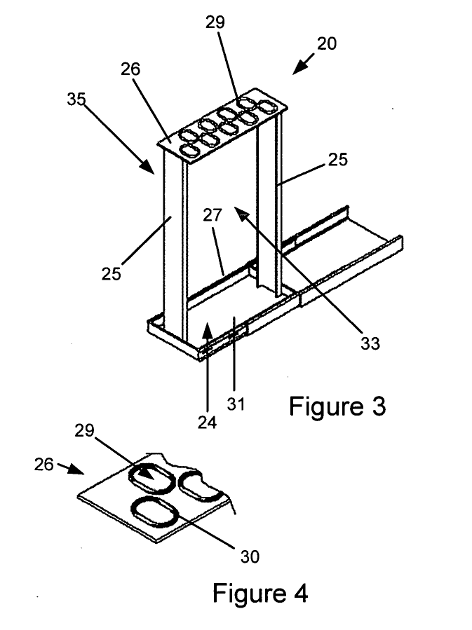

FIG. 2 depicts an exemplary enclosure 10 with pull-out gun racks 20 extended in accordance with the present invention. As shown in FIG. 2, the pull-out gun racks 20 can be extended on the rails 22 to a position outside the enclosure 10. When the pull-out gun rack 20 is at a position outside the enclosure, a user may access the firearms from either side of the pull-out gun rack 20. The pull-out gun racks 20 can include a handle 23, for example, to facilitate movement from inside the enclosure 10 to a position outside the enclosure 10. As depicted in FIG. 3, the pull-out gun racks 20 can include a bottom 24, a top or support member 26, and arms 25 secured to both the bottom 24 and top 26. The configuration of bottom 24, top 26, and arms 25 define a first opening 33 and a second opening 35. The bottom 24 can include a lip 27 to prevent firearms from shifting off the bottom 24. The pull-out gun racks 20 can be composed of aluminum, for example. The pull-out gun racks 20 can also be composed of ferrous or non-ferrous materials, for example.

The pull-out gun racks 20 can include a top 26 having a plurality of openings 29. The openings 29 can be staggered to allow for maximum occupancy of firearms. The position of the openings 29 can also allow for the firearms, for example, to be oriented in different directions. The openings 29 may be elliptical, for example, or any other shape to promote the receiving of the firearm. FIG. 4 shows a detailed view of a portion of the top 26. As shown in FIG. 4, the openings 29 can include an insulated rim 30 to help protect firearm barrels, for example, from being damaged by the opening 29. The insulated rim 30 can be composed of plastic or rubber, for example. The upper surface 31 of bottom 24 of the pull-out gun rack 20 can be textured, for example, to promote friction between the upper surface 31 of bottom 24 and the butt of a firearm (not shown). The bottom 24 can also be carpeted, for example.

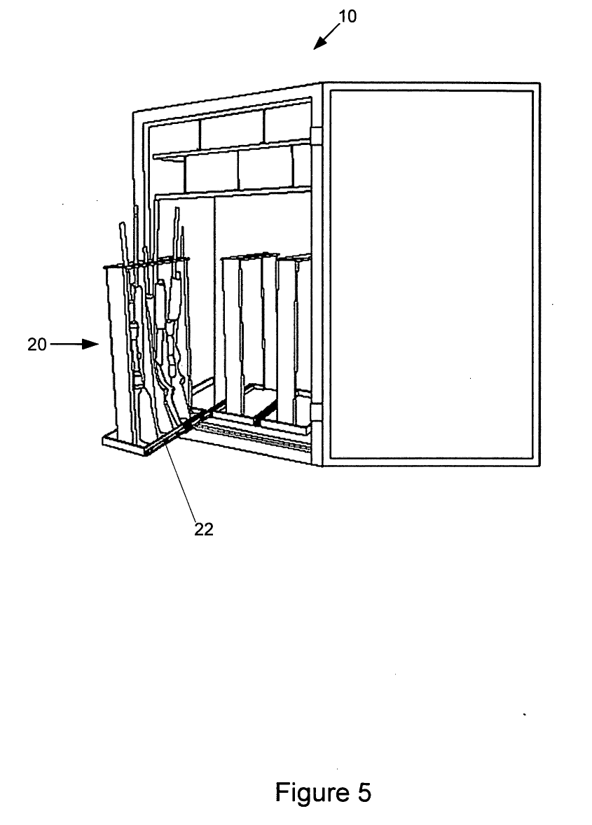

As depicted in FIG. 2, the rails 22 can be secured to bottom surface 14 of the enclosure 10. The rails 22 may be composed of stainless steel, for example. The rails 22 may also be composed of other ferrous and non-ferrous materials, for example. Further, a plurality of rails 22 may be secured to the bottom surface 14 of the enclosure 10 to allow for a plurality of pull-out gun racks 20. For example, FIG. 5 depicts an exemplary enclosure with a set of three pull-out gun racks in accordance with the present invention. A user may take valuables or firearms from the pull-out gun racks 20 or set valuables or firearms in the pull-out gun racks 20 from either side of the pull-out gun racks 20 because of the first opening 33 and the second opening 35. A latch or lock (not shown) can be used to lock or secure individual pull-out gun racks 20 in an extended position or in a non-extended position to prevent movement when shipping the gun rack, for example, or in case of a situation where the enclosure 10 is positioned on a slope.

The pull-out gun racks 20 can vary in size. The pull-out gun racks 20, for example, can be shorter in height to allow for the securing of smaller valuables and firearms. The pull-out gun racks 20, for example, can also be narrower to facilitate having multiple racks situated in the enclosure 10.

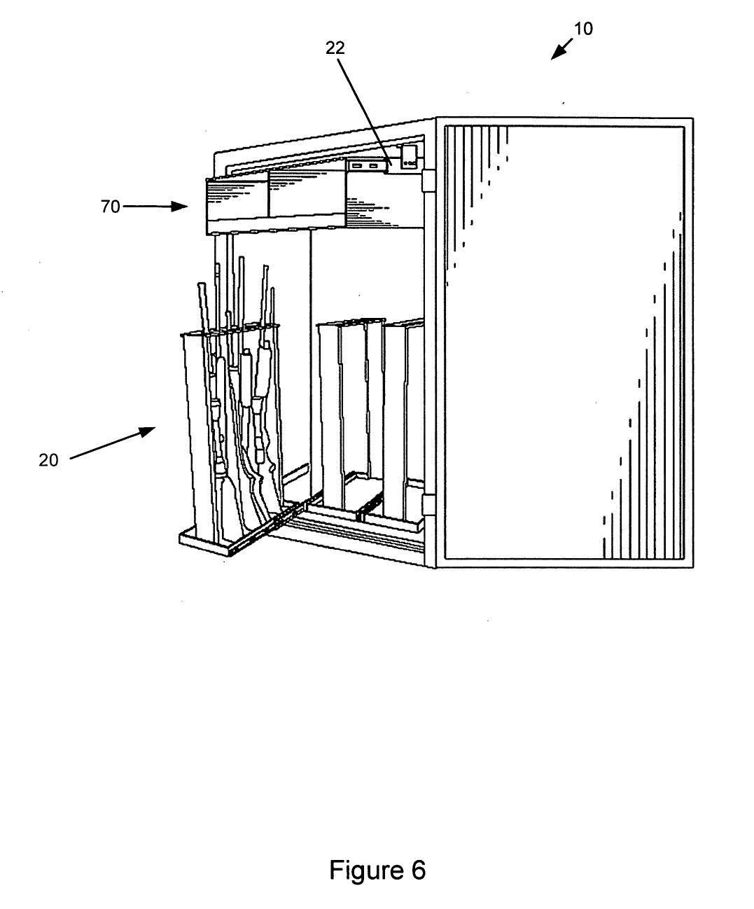

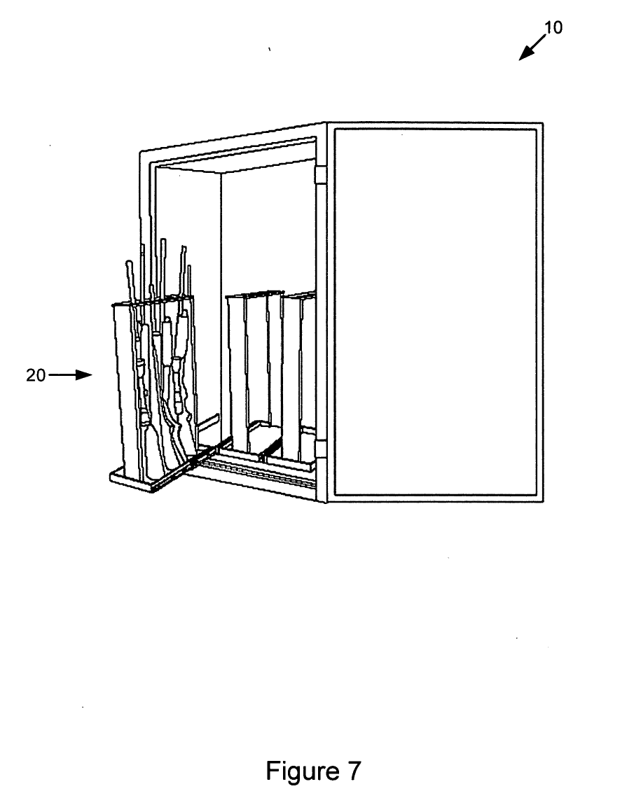

FIG. 6 is an isometric view of an exemplary enclosure with a pull-out gun rack 20 and an overhead pull-out gun rack 70 in accordance with the present invention. As depicted in FIG. 6, an additional set of rails 22 can be secured to the top surface 12 of the enclosure 10 to allow for an overhead pull-out gun rack 70. The overhead pull-out gun rack 70 can be open ended, as shown, to allow a user to simply place or remove items through the open end. The overhead pull-out gun rack 70 can also have a closed end (not shown) to preclude the placing of items into the overhead pull-out gun rack 70 unless to overhead pull-out gun rack 70 is extended on the rails 22. The overhead pull-out gun rack 70 can also include an additional locking device (not shown) to allow for additional security. In an instance where space is limited and large firearms or valuables must be stored, the enclosure 10, may only be incorporated with pull-out gun racks 20 without shelving units 17 or overhead pull-out gun racks 70 as depicted in FIG. 7.

Additionally, the pull-out gun racks 20 can be incorporated in new enclosures, for example. The pull-out gun racks 20 may also be part of a retro-fit kit allowing users to incorporate the pull-out gun racks 20 in existing enclosures and gun safes.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims.

What is claimed:

1. A racking system for storing firearms and other valuables, comprising:
at least one first rail, wherein said at least one first rail is secured to a bottom interior surface of an enclosure; and
at least one rack secured to said at least one first rail so that said at least one rack is slidably attached to the enclosure, and wherein said at least one rack comprises a bottom for supporting firearms, a top having a plurality of openings, and a set of arms connecting the bottom and the top.

2. The racking system as recited in claim 1, wherein said at least one rack includes three or more racks.

3. The racking system as recited in claim 1, further comprising a second rail, wherein said second rail is secured to a top interior surface of the enclosure.

4. The racking system as recited in claim 3, further comprising at least one drawer secured to said second rail so that said at least one drawer is slidably attached to the enclosure, wherein said at least one drawer can independently move in relation to said at least one rack.

5. The racking system as recited in claim 1, wherein the top of said at least one rack comprises a plurality of staggered openings for receiving the firearms.

6. The racking system as recited in claim 5, wherein the plurality of openings are elliptical.

7. The racking system as recited in claim 5, wherein the interior surface of the plurality of openings is insulated.

8. The racking system as recited in claim 1, wherein said at least one first rail is composed of stainless steel.

9. The racking system as recited in claim 1, wherein the said at least one rack is composed of aluminum.

10. The racking system as recited in claim 1, further comprising a shelving unit to allow for further storage of valuables.

11. The racking system as recited in claim 1, wherein the enclosure is a firearm safe.

12. An enclosure for storing firearms, comprising:
a first rail disposed in the enclosure; and
a first rack secured to said first rail to allow said first rack to move in and out of the enclosure, wherein said first rack comprises a support member including a plurality of staggered openings for receiving firearms.

13. The enclosure as recited in claim 12, further comprising a second rail secured to a top interior surface of the enclosure and a second rack secured to said second rail to allow said second rack to move in and out of the enclosure.

14. The enclosure as recited in claim 13, wherein the second rack is a drawer that includes a locking device to provide additional security.

15. The enclosure as recited in claim 12, wherein said first rail is composed of stainless steel and said first rack is composed of aluminum.

16. The enclosure as recited in claim 12, wherein the plurality of staggered openings are elliptical.

17. The enclosure as recited in claim 12, wherein the interior surface of the plurality of staggered openings is insulated.

18. The enclosure as recited in claim 12, wherein the enclosure is a firearm safe.

19. An enclosure for storing firearms, comprising:
a first rail disposed in the enclosure; and
a first rack for securing valuables secured to said first rail to allow said first rack to move in and out of the enclosure, wherein said first rack comprises a bottom, a support member, a pair of arms connecting the bottom to the support member, a first opening defined between the pair of arms, and an opposing second opening defined between the pair of arms, wherein the valuables are accessible from the first opening and the second opening.

20. The enclosure as recited in claim 19, further comprising a second set of rails secured to a top interior surface of the enclosure and a second rack secured to said second set of rails to allow said second rack to move from a position inside the firearms safe to a position substantially outside the firearms safe.
